(19) United States
(12) Patent Application Publication
(10) Pub. No.: US 2008/0191719 A1
(43) Pub. Date: Aug. 14, 2008

(54) Device And Method For Measuring The Width Of Touch Between Rollers

(75) Inventor: Antoine Philippe Krier, Villepreux (FR)

Correspondence Address: YOUNG & THOMPSON, 209 Madison Street, Suite 500, ALEXANDRIA, VA, 22314, US

(73) Assignee: KRIER S.A., Plaisir (FR)

(21) Appl. No.: 11/911,031

(22) PCT Filed: Apr. 6, 2006
(86) PCT No.: PCT/FR2006/000767

§ 371 Date: Oct. 9, 2007

(30) Foreign Application Priority Data
Apr. 6, 2005 (FR) 0503403

(51) Int. Cl. G01B 5/04

(52) U.S. Cl. 324/699; 33/700

(57) ABSTRACT

The invention relates to a device for measuring the pressure between two rollers tightly placed against one another or the deformation caused by this pressure in their mutual contact area. The invention is for use in the fields of machines and mechanical assemblies comprising rollers pressed against one another, for example, in printing presses or rolling machines. A crushing width can also be measured, for example, for a deformable seal or a line of glue or cement in an assembly process. This device comprises a thin sensor to be inserted between the rollers and whose shape has a return (14) provided in such a manner that, when the sensor is in a measuring position, the mechanical connections (131) connecting the sensor to the maneuvering part are situated in the squeezing area or on the side opposite the maneuvering part with regard to the squeezing area (ZP).

This invention relates to a device for measuring the pressure between two rollers pressed against each other, or the deformation caused by this pressure in their mutual contact zone.

The invention is applicable to the fields of machines and mechanical assemblies comprising rollers pressed against each other, in particular rollers having axes parallel to each other. These can be in particular any type of machines with rollers, for example printing presses or laminating machines.

The invention can also be applicable to other situations where it is desired to measure a compression width, for example for a deformable seal, or a line of adhesive or mastic in an assembly process.

In particular during assembly or maintenance operations, it is often necessary to control the pressure existing between two rollers, for example with parallel axes and in contact along a linear contact zone parallel to their axes. This contact zone has a certain width which is due to a deformation of the rollers against each other, resulting from the pressure between them. When one of the rollers has or both rollers have a relatively high deformability, for example for flexible rollers such as inking rollers or dampeners, or due to a resilient layer such as a rubber blanket, it is very common to assess the pressure between the rollers by measuring the width of this contact zone.

This measured width is for example called “nip width”.

This measurement of nip width is very widespread, to the point where many machine manufacturers supply documentation specifying the acceptable or recommended pressure values across their corresponding nip widths.

Standard manual methods have long existed, for example by insertion of a calibrated foil or by inking. When using a metal or plastic foil, i.e. a thin strip, this foil is inserted transversely in slow rotation between the two rollers to be tested, then the traction required to withdraw the foil when the rollers are stationary is assessed. In the case of inking rollers in particular, the rollers are rotated while covered with a thin layer of ink, then stopped suddenly at a stopping point. By suddenly performing a new rotation of approximately one half-turn, the contact zone of the stopping point is discovered, where the patterns of the ink correspond approximately to the sought nip width.

In order to obtain a simpler and more precise measurement, there is now equipment for measuring by contacts of electric tracks under the pressure of the rollers in the contact zone. American patent U.S. Pat. No. 6,370,961 thus describes a device comprising a sensor including a resistive track through which an electric current passes, arranged facing a conductive track from which it is separated by spacers. Once the sensor is inserted between the rollers, their pressure places the two tracks in contact with each other over the whole width of the contact zone. By measuring the variations in resistance between different electric poles of these tracks, the length of the resistive track short-circuited by its contact with the conductive track is assessed, and therefore the value of the nip width.

However, such a solution has a certain number of drawbacks, in particular for quick and simple use. Thus, during the introduction of a sensor of this type between the rollers by a user, the movements or the forces due to the user can easily cause deformation of the sensor, which risks creating distortion of the measurements obtained. Moreover, the solution consisting of increasing the thickness of the sensor to improve its rigidity also leads to distortions of the measurements, since there is then a risk of the thickness of the sensor altering the compression and therefore the nip width itself.

Moreover, these systems contain risks of measurement errors, for example in the case of incorrect positioning of the sensor between the rollers. There is a risk for example that the user will fail to note that the contact zone clearly extends beyond the end of the measurement tracks, and thus record an incorrect figure. The sensor can also give incorrect measurements owing to damaged or dirty tracks, for example owing to dust or ink or solvent vapours.

Moreover, the measurements provided by this type of sensor tend to vary from one measurement session to another, and even between several measurements in the same session, in particular because of variations in environmental conditions.

Moreover, several successive measurements can present different results on a single sensor, if they are carried out at different points on this sensor.

A purpose of the invention is to overcome all or some of these drawbacks.

To this end, the invention proposes a device for measuring the width of a nip contact zone between two rollers, operating by insertion of at least one thin sensor between said rollers. This device comprises on the one hand, a handling part for introducing said sensor between the rollers to be tested and on the other hand a measurement part comprising said sensor. The shape of this measurement part has, in the direction of the handling part, a back tab arranged such that, when the sensor is in the measurement position, the mechanical links connecting the sensor to the handling part are situated in the nip zone or the side opposite to the handling part relatively to said nip zone.

The sensor is advantageously fitted and connected in a manner so as to be easily and quickly interchangeable.

For the measurement, the measurement part is inserted between the rollers such that the nip of the rollers acts on the sensor to enable the contact zone to be measured.

Since the mechanical links between the sensor and the remainder of the measurement part are situated on the other side of the nip, the handling part transmits fewer spurious forces or even none at all to the sensor. The latter experiences fewer deformations, and can deliver a reliable measurement regardless of the movements of the user. It is thus possible to carry out reliable and accurate measurements more quickly, more simply, and taking fewer precautions.

In order to deal with the variations in measurements, the invention moreover proposes a method of measurement comprising steps of calibrations particularly suited to this type of sensor.

This method is applicable as part of a measurement of the width of a nip contact zone between two rollers by a device with an interchangeable sensor using measurement of the reduction, relative to a reference value, of the ohmic resistance of an electric circuit comprising a resistive track short-circuited by contact with a conductive track over a nip length, within a thin sensor inserted between said rollers.

In particular, this method carries out a dynamic and automatic self calibration, during a session of several measurements carried out with the same sensor, and comprises the following steps at the start of the session:
measurement of the ohmic resistance of the electric circuit under stand-by conditions and comparison of the value obtained, termed initial value, with a range of values termed wide range associated with said sensor;
if the initial value is within the wide range, storage of a range of values, termed narrow range, associated with said sensor and obtained from the initial value.

This narrow range can be regarded as representing a range of values within which the total resistance of the resistive track can develop, during a measurement session. This narrow range can also represent a range of neutral values, within which there is no need to assess or to display a measurement.

During said measurement session, the method moreover comprises an iteration of the following steps:
measurement of the ohmic resistance of the electric circuit, and comparison of the value obtained with the narrow range;
if the value obtained is within the narrow range, storage of a new narrow range, determined from the value obtained (this new narrow range then constitutes an automatic re-calibration of the device).
if the value obtained is outside the narrow range, calculation of a measured value, determined from the value obtained and a reference value dependent on the narrow range (the device considers that it is in a measurement situation, and displays or uses the measured value as such).

Optionally, the method may comprise a narrow range determining, or not the automatic re-calibration, and a wider intermediate range determining a minimum threshold for calculation or display of the measurement value.

More particularly, the method may moreover comprise one or more error displays indicating a malfunction of the sensor, for example a faulty contact in the circuit. These error displays are produced if the resistance value obtained at the start of a session is above the wide range, or if the resistance value obtained during the session is above the wide range, or above the intermediate range.

For the same type of measurement, the invention also proposes to link the calibration with a particular sensor and thus comprises the following steps:
insertion of the sensor between the rollers during a continuous rotation of said rollers at a constant speed or on a known travel;
during this insertion, automatic carrying out of a plurality of measurements at different insertion depths corresponding to different measurement positions on said sensor;
storage of a profile corresponding to said sensor and comprising said measurements, or their variations, each linked with their corresponding measurement position; and

Once the profile of the sensor is memorized, at least one measurement of nip width carried out using said sensor then comprises the following steps:
measurement of at least a resistance providing a measured value of nip width as well as a measurement position on the sensor for said measurement;
comparison of said measurement position with at least one datum from the profile corresponding to said sensor;
according to the results of this comparison, modification of the measured value to give a corrected value of the nip width.

Other features and advantages of the invention will become apparent from the detailed description of an embodiment which is in no way limitative, and the attached drawings, in which:

FIG. 1 shows the measurement device, according to an embodiment of the invention, during insertion between two rollers to be tested;

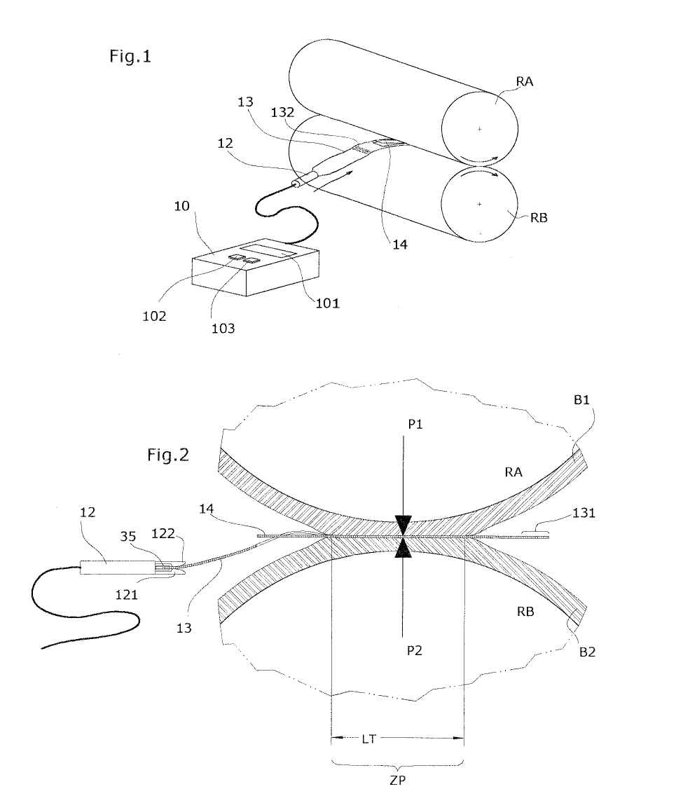

FIG. 2 is a longitudinal sectional view of the measurement device in position between two rollers;

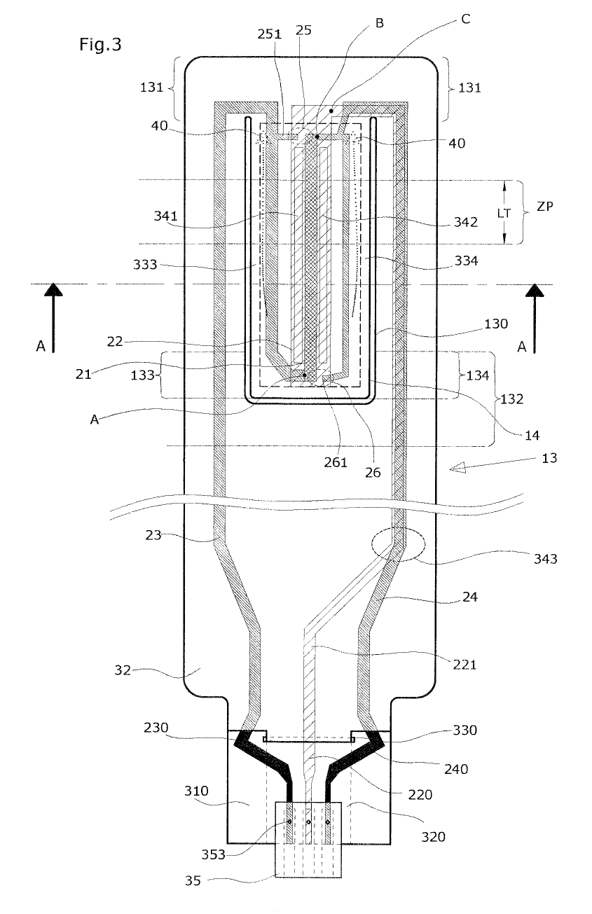

FIG. 3 is a phantom view from above of the device in the measurement position;

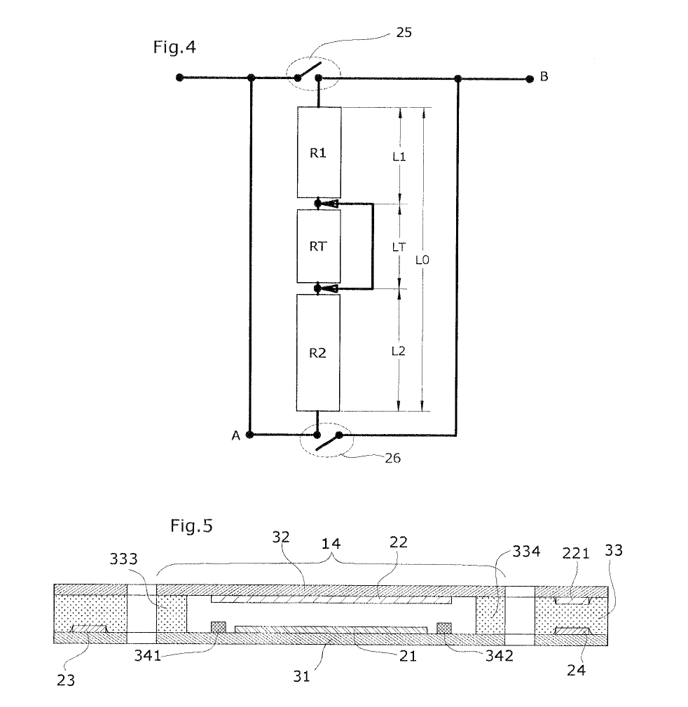

FIG. 4 is a wiring diagram corresponding to the measurement device in the measurement position;

FIG. 5 is a cross-sectional view (along AA—FIG. 3) of the detection zone of a sensor according to the invention;

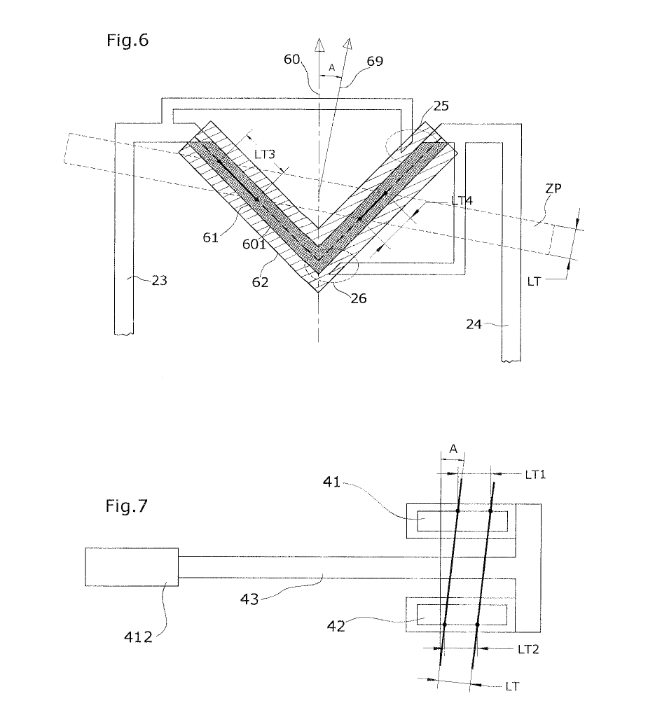

FIG. 6 shows an embodiment of the invention comprising a “V”-shaped detection zone; and

FIG. 7 represents an embodiment of the invention comprising two detection zones parallel to each other.

As shown in FIG. 1, the device comprises a handling part to enable a user to hold and insert the measurement part between the rollers to be tested RA and RB. The handling part comprises for example a grip 12 connected to a box 10 comprising calculation, control and display means. These means may also be included in the handle, or may communicate with the sensor by any means of communication with or without wires.

In the embodiment described here, the measurement part comprises a tongue 13 one end of which forms a back tab 14 towards the handling part. This back tab 14 carries the sensor in a zone closer to the handling part than the part 131 of the tongue 13 holding said back tab 14.

This back tab 14 is determined by a blind, essentially U-shaped cut-out 130 (FIG. 3) in the tongue 13, the opening of which is directed towards the side opposite to the handling part 12. Thus, the back tab 14 carrying the sensor is mechanically connected to the remainder of the tongue 13 only by a part 131 situated on the side opposite the handle 12.

As shown in FIG. 2, the nip width is the width LT of the contact zone created by the elastic deformation of the surface of the rollers by the deformation of the rollers or a covering or the compressed material, for example inking rollers made of rubber or rollers coated by rubber blankets B1 and B2.

When the tongue 13 is inserted between the rollers RA and RB, the pressure between the rollers RA and RB exerts opposing pressures P1 and P2 on the upper and lower faces of the tongue 13 and of the sensor that it carries. As soon as these pressures P1 and P2 are sufficiently strong relatively to the unwanted forces received from the handle 12, the part of the tongue extending on the side opposite the handle 12, beyond the contact zone LT to be measured is held only by the rollers. Thus it does not experience any unwanted deformation relative to its natural shape and remains properly flat.

The back tab 14 carrying the sensor comprises a proximal part situated on the same side as the handle 12, but its only mechanical link to this handle is a part 131 which is situated on the other side of the nip zone LT. Thus the proximal part of the sensor does not experience unwanted forces from the handle either. Thus, the sensor assembly does not experience deformation relative to its natural shape and remains properly flat.

As shown in FIG. 3, the sensor is of the type having at least one linear detection zone comprising a resistive track 21 and a conductive track 22 which are parallel to each other and arranged facing each other in what is called the active zone. In this active zone, the compression places these two tracks 21 and 22 in contact with each other over the width LT of the contact zone of the rollers. On the part where they are in contact (in fine cross-hatching in FIG. 3), the conductive track 22 short-circuits the resistive track 21, thus varying the ohmic resistance of an electric circuit comprising any part of the resistive track and through which an electric current passes, thus detecting this resistance or its variation. This circuit advantageously comprises a steady electric current generator, coupled with a volt meter across the terminals of the resistance to be measured.

In the embodiment described here, the resistive track 21 is a linear segment (in medium cross-hatching in FIG. 3), arranged substantially along the direction of insertion of the sensor. Each end of this resistive track 21 is electrically connected to a link track 23 and 24, advantageously of low resistance. These link tracks run along the tongue 13 up to its end alongside the handling part 12.

In the active zone, the conductive track 22 comprises a linear segment having almost zero resistance (broad hatching in FIG. 3), superimposed on the resistive track.

FIG. 4 represents an example of an electrical circuit which may correspond to this type of sensor. The resistive track has a length L0 and thus has a total resistance R0 when it is not in contact with the conductive track 22. For reasons of simplicity, the resistive track 21 is advantageously produced so as to have a more or less uniform linear resistivity.

When the two tracks 21 and 22 are in contact over a width LT, the resistive track 21 can be viewed as comprising three resistors in series R1, RT and R2, of which the middle one RT is short-circuited by its contact with the conductive track 22. Seen from its ends A and B, the resistive track 21 then behaves like two resistors in series R1 and R2, proportional to the lengths L1 and L2 which are not short-circuited.

By measuring the variation in resistance between the ends AB of the resistive track 21, the calculation means provide a value representing the contact length LT between the two tracks 21 and 22 in the active zone, which can then be displayed by the means of display 101.

A linear detection zone of this type can carry out a measurement at different insertion depths between the rollers.

Advantageously, the calculation means also use resistance measurements taken between a point C of the conductive track 22 and one or other of the ends A or B of the resistive track 21. The conductive track 22 is electrically connected to a low-resistance link track 221.

These measurements are used to calculate on the one hand, the length of resistive track short-circuited by the pressure in the nip zone ZT, and on the other hand, the length L1 and L2 of the resistors R1 and R2 (cf. FIG. 4) situated on each side of this nip zone. The device may use these values to calculate the position of the nip zone over the length of the sensor, as well as its movement. It may also use a time base to measure the speed of movement of this nip zone, and therefore the speed of the rollers.

During a self calibration step carried out before insertion between the rollers, the calculation means measure the total resistance R0 of the resistive track 21 before the insertion. This step of self calibration may be ordered by a calibration button 102.

In an automated variant, this self calibration is permanently performed automatically, continuously or regularly, as long as the sensor is live and is not inserted between the rollers.

To carry out this automatic self calibration, the calculation means have available in memory an approximate value for the total resistance R0 of the resistive track 21, for example 4 kiloOhms, as well as a wide range of possible variations, for example plus or minus 20%, and a narrow range, for example plus or minus 2% or plus or minus 0.1 kiloOhm.

When the device is activated, the calculation means measure the resistance and verify that the measured value is actually in this wide range, indicating that the tongue is certainly at rest.

The measured resistance, for example 3.8 KiloOhms, is then memorized as a temporary value, until switch-off, for the total resistance R0 of the resistive track 21.

As long as the device remains live, the resistance is measured permanently or regularly, for example several times per second.

Each time this measured resistance is within the narrow range around this temporary value, for example between 3.7 and 3.9 kiloOhms, the device considers that the tongue is still at rest and memorizes the measured resistance as the exact value for the total resistance R0 of the resistive track 21, thus carrying out a permanent automatic self calibration.

As soon as the measured resistance falls outside this narrow range around the temporary value, the device considers that the tongue is in the measurement position. It then uses the measured resistance to assess the value of the nip width, based on the calibration during validating, namely on the last exact value memorized for the total resistance R0, or on an average of several of these values.

To display the measurement, a conversion button 103 may be used to carry out a conversion of the displayed value between a resistance value and a nip width value.

The device may also carry out a cartographic calibration of the sensor, so as to deal with any irregularities in the linear resistivity of the resistive track 21, and thus obtain a truer measurement, whatever the depth of insertion between the rollers.

This cartographic calibration is carried out recording the resistance values measured successively or continuously by the sensor, during an insertion between two rollers turning at a constant speed or along a known travel. During the movement of the nip zone along the sensor, the device records the variations in resistance, indicating for example a nip width varying from 1.9 mm to 2.2 mm. For an actual nip width assumed to be constant regardless of the depth of insertion of the sensor, these measurements act to gauge the characteristics of the sensor at different points along its length. These measurements are memorized linked with the cartographic sensor, and are used during subsequent measurements to correct each value in relation to the zone of the sensor which enabled it to be obtained.

These calibration and measurement methods typically enable a precision of the order of plus or minus 0.1 mm for a measured nip width of 4 mm, which represents a significant improvement in relation to precision figures of the order of plus or minus 0.4 mm which are typical of the prior art.

According to a particularly advantageous feature of the invention, at least one of the ends of this linear detection zone has a region forming an end marker 25 or 26 the detection characteristics of which are chosen such that the sensor delivers a measured value which is significantly different when the contact zone LT to be measured meets said end point.

More particularly, the design of the resistive tracks 21 and conductive tracks 22 is arranged so as to short-circuit at least one significant part of the resistance of the circuit when the contact zone LT meets at least one end of the linear detection zone, thus realizing an end marker of such type.

As shown in FIG. 3, a conductive portion of track termed marker contact 251 and 261 is arranged at each end of the resistive track 21 along the direction of insertion of the sensor between the rollers, facing this end but non connected to the resistive track 21 itself. Each of these marker contacts 251 and 261 is electrically connected to the link track (A respectively B) coming from the other end of the resistive track 22.

These two marker contacts 251 and 261 are close to the resistive track 21, and the conductive track 22 is sufficiently wide to place the end of the resistive track in contact with the marker contact which is close to it when the nip zone meets this end region. When the measured contact zone LT reaches an end of the active zone, the conductive track thus short-circuits the two ends of the resistive track 21, and thus delivers a measured value which varies substantially and suddenly compared with the measurements obtained between these ends. On the wiring diagram of FIG. 4, these end markers 25 and 26 are represented in the form of limit switches.

Thus, when the user turns the rollers in order to insert the tongue there, a sudden variation in the measured value enables him to recognize easily that the insertion is reaching one end of the detection zone.

Thus the mistaken use of measurements which would be falsified by an incorrect insertion can more easily be avoided.

FIG. 5 represents a section of the part of the tongue 13 forming the back tab 14 and carrying the sensor, transversely to the direction of insertion.

According to one feature, the tongue comprises at least two stacked films 31 and 32 carrying the resistive and conductive tracks 21 and 22 on their facing sides. Said tracks are advantageously formed by an ink having respectively resistive and conductive characteristics.

When they are brought together by the pressure of the rollers, the resistive and conductive track 21 and 22 between them create an electric contact by at least one carbon-based substance. This may be for example an ink containing graphite, or a layer of graphite laid on the surface of a track, or both.

These films are for example made of thin polyester, for example of a thickness of the order of 80 to 150 micrometres and typically 100 micrometres, cut out and assembled by gluing or welding on their perimeter.

The invention enables a particularly simple and inexpensive manufacture of this tongue containing the measurement sensor.

During an operation of the machine for testing nip widths, it may happen that the rotation of the rollers does not always stop exactly as the operator desires. In the event of such an incident, the tongue according to the invention can easily be detached or torn from the handling part. The invention thus enables the risks of pulling hard or bulky items, such as a handle or an electric box, or even the operator's hand through the rollers, to be limited. The consequences of an incident of this type are thus advantageously minimized, for example risks to the safety of the operator or deterioration of the rollers or the machine. Similarly, the measurement device is at less risk of deterioration, apart from the tongue which can be replaced easily and at low cost.

The arrangement of the means 131 of mechanically linking the sensor to the remainder of the tongue enables a good independence between these two elements. The invention thus enables the tongue to be produced in a particularly small thickness without compromising the reliability of the measurements. This small thickness then itself constitutes a small disturbance vis-à-vis the gap between the rollers and the nip width or the pressure to be measured, which enables a good accuracy and good performance levels in the measurements.

More particularly, the two films 31 and 32 are joined by a layer of adhesive over the whole surface of the tongue outside of the sensor or its detection zone, for example a layer of adhesive or a double-sided adhesive film 33.

This adhesive is of insulating type and also enables the insulation of one part from the other of the tracks arranged facing each other on the two films 31 and 32 outside the active zone, for example in a zone 343 where the routes of several link tracks 221 and 24 meet. This feature thus enables more freedom in the choice of the design of the tracks outside the detection zone.

As shown in the figures, the tongue 13 comprises over a part of its length, for example between 0.5 and 5 cm, a zone 132 having a greater flexibility than over the remainder of its length.

This more flexible zone 132 is situated between the handling part 12 and the back tab 14 carrying the sensor. This more flexible part 132 carries out a kind of articulation which enables to reduce the mechanical forces transmitted from said handling part during the introduction or the measurement, while still retaining a certain stability for the tongue assembly during handling operations.

This greater flexibility is obtained by reducing the thickness of the tongue in this zone, for example by means of a reduction in the number or thickness of one or more of the layers constituting this tongue. This reduction may be achieved by making a break in a layer on this zone. It may also be obtained by a modification of one or more layers, by local stretching, or by local deformation such as grooving, or by removing material such as by abrasion or by etching.

In an advantageous embodiment tested later during development, films 31 and 32 are made of polyester, each of a thickness of 50 micrometres or 36 micrometres or 23 micrometres. The use of a small thickness for the back tab part 14 carrying the sensor makes it possible to limit measurement errors resulting from the excess thickness represented by the sensor between the rollers, compared with the values obtained by measurement methods obtained with the rollers directly in contact with each other.

The flexible zone 132 contains a break in the adhesive film 33, which in this zone enables a reduction in thickness and a desolidarization of the two films 31 and 32, increasing flexibility.

As shown in FIG. 3, this flexible zone 132 may advantageously encompass a part 133 and 134 of the branches of the tongue surrounding the back tab 14. The narrowness of these branches combined with the better flexibility of these parts 133 and 134 also enables a further reduction of the forces transmitted to the sensor from the handling part 12.

On one of its faces or on its two faces, the tongue 13 carries a label identifying said face. When the nip width is measured in two different positions between the same two rollers, this label enables easy verification that the tongue is actually in the same direction for each measurement, be these measurements simultaneous with two tongues or successive with the same tongue. It is thus possible to limit measurement errors which may result for example from a different reaction of the tongue according to its direction of insertion.

For example if the tongue is intended to measure the nip width between a flexible roller and a hard roller, this label will include a legend “hard roller side” on one side and a legend “flexible roller side” on the other side.

On one face or its two faces, the back tab 14 of the tongue 13 moreover contains a pattern marking the central zone or the optimum measurement zone, and enabling easy adjustment of the depth of insertion of the tongue between the rollers. This pattern has for example a design reducing in width from the ends of the measurement tracks to the central or optimum zone to be marked. This pattern also comprises a periodicity according to the direction of insertion of the tongue, for example transverse parallel short stripes decreasing in length towards the central or optimum zone.

More particularly, at least one linear detection zone contains at least one region bearing an insulation layer sufficiently thick to ensure that the tracks facing each other are not in contact with each other unless they are subjected to compression by the rollers.

This thickness is constituted for example by at least one layer of insulating varnish or a calibrated film covering at least part of said tracks, in a region outside the active zone where they face each other. This insulating varnish makes it possible to obtain simply a calibrated space around at least part of the active zone of the tracks.

As shown in FIGS. 3 and 5, this varnish may for example be affixed in the form of two lines 341 and 342 applied in parallel and on both sides of the resistive track 21, facing the conductive track 22.

In an embodiment presenting satisfactory performance values, the resistive track is approximately 6 micrometres thick and approximately 4 mm wide, and these spacers are produced in a thickness of approximately 17 micrometres, and situated inside the width of the conductive track, i.e. approximately 7 mm.

Advantageously, the space between the films 31 and 32 is substantially dust-tight. The tracks and their contact surfaces are then protected against dirt, abrasions or incrustations of dust which could impair them or disrupt the quality of the contact between them. This space may also be tight vis-à-vis liquids or gases. It is thus possible to avoid deterioration or inks due to liquid solvents or vapour solvents, or dirt resulting from various fatty substances or adhesives.

In the back tab part 14 containing the sensor, the adhesive film 33 completely surrounds the linear detection zone containing the active zone. Along the whole length of the cut-out forming this back tab 14, this film is applied over a width of approximately 2 mm or more, and thus provides air- and gas-tightness around the detection zone of the sensor.

According to a feature, the part (14) of the tongue (13) forming the sensor is arranged such that the space between the films (31, 32) around the active zone communicates on either side of the nip zone. In the nip zone, this communication is maintained around the spacers 341 and 342, and along the edges 333 and 334 of the adhesive 33, owing to the thickness of this adhesive. During the insertion between the rollers, this communication thus enables exchanges of air 40 between the interior space, in the sensor, situated on either side of the nip zone. These exchanges enable to avoid or limit the risks of overpressure in the sensor which could inflate it, deform it and distort the measurements.

According to the invention, the linking conductive tracks 23 and 24 which connect the detection tracks 21 and 22 to the electric measurement device 10 are drawn on the same face of the films 31 and 32 of the tongue 13 of said detection tracks. Thus, the linking tracks 23 and 24 connected to the two ends A and B of the resistive track 21 are carried by the same film 31 as said resistive track. For its part, the linking track 221 connected to point C of the conductive track 22 is carried by the same film 32 as said conductive track.

Moreover, the tongue 13 includes at least one linking part in which at least one film 31 or 32 carrying the tracks is cut out or folded such that its face carrying the linking track 23, 24 or 21 appears on the external surface of said tongue.

The fact that the linking tracks appear on the external face of the tongue makes it possible to create more simply and more reliably the electric connection between these same linking tracks and the handle 12, with connecting wire connectors and with an electric or electronic measurement device.

In the embodiment described here, the tongue 13 is fixed to the handle 12 by clamping its connecting part, situated on the side opposite to the measurement part, in a device with jaws 121 and 122 carried by said handle 12.

In this connecting part, the film 31 carrying the link tracks 23 and 24 has a cut-out in the form of a short strip 310 including the ends 230 and 240 of these same tracks, directed towards the end of the connecting part. For its part, the film 32 carrying the link track 221 has a cut-out in form of a short strip 320 including the end 220 of this same track 221, directed towards the end the connecting part of the tongue.

A little before the edge of the connecting end, the tongue has a cut-out, for example a slit 330 in the short strip 310 carrying the two link tracks 23 and 24. The connecting short strip 320 projecting from the film 32 crosses this slit 330, so as to be opposite the other face of the other film 32. Where the link tracks which were on the face of each film inside the tongue thus appears on the external face of this same tongue, on the end of its connecting part.

As shown in FIG. 3, the link tracks 23, 24 and 221 are electrically connected to a plug-in connector 35, which clamps their ends 230, 240 and 220 in metal crimping plugs. During the crimping, these metal plugs each comprise a metal grip 353 which crosses the two films of the tongue 13 inside the surface of an end 230 of link track 23. The fact that the connecting ends of the tracks are arranged on the external face of their respective films then makes it possible to obtain a good contact with the electric contact, or with the grip 353 which forms a part thereof.

Moreover, the two link tracks 23 and 24 of the resistive track 21 are arranged symmetrically on either side of the end 220 of the link track of the conductive track 22. Thus, during the connection of the tongue to the handle 12 or to the electric control box 10, the connector 35 may be plugged in equally well in either direction, without risk of inverting the connections of the resistive track 21 and conductive track 22.

According to a variant not shown here, the jaws 121 and 122 of the handle 12 may comprise on their internal faces means of electric contact, for example metal pads connected to the electric measurement device 10 These jaws close elastically on the connecting part of the tongue, and are arranged such that the pads rest on the visible parts of the ends 230, 240 and 220 of the link tracks 23, 24 and 221.

This type of connection is much simpler to produce and use, in particular for fitting or replacing a tongue on the handle, than if it were necessary to introduce each film into a clamp or to create an insert coming into contact with the link tracks on the internal faces of the films.

According to the embodiment variants, the back tab carrying the sensor may have different forms.

Thus, the sensor may comprise a detection zone along a line 601 displaying a symmetry about the axis of insertion of the tongue 13. This line is arranged such that the nip zone ZP crosses the detection zone in two separate portions of its line and the combined lengths of which represent a value more or less independent of the angle of insertion of said tongue.

As shown in FIG. 6, a detection zone of this kind may comprise an active zone in the form of a symmetrical “V” around the axis 60 of the tongue, provided for its insertion between the rollers. This active zone comprises a resistive track 61 in a “V”-shape along this line 601, facing a conductive track 62. When the tongue is inserted along an actual insertion axis 69 having an angle A to the axis 60 provided, the two tracks 61 and 62 are short-circuited on two separate portions of lengths LT3 and LT4. According to the variation of the actual insertion angle A, it can be seen that the combined length of these two portions LT3 and LT4 has a smaller variation than in the case of a monolinear detection zone as described in the embodiment shown in FIG. 3.

A feature of this kind enables a measurement to be obtained for the actual nip width LT which varies less when the tongue is not inserted truly straight between the rollers to be tested.

FIG. 7 shows yet another embodiment in which two sensors 41 and 42 parallel to each other are arranged at the end of a thin T-bar 43. These two sensors are fixed on the lower part of the two arms of the “T” and are directed towards the handling part, which itself comprises a handle 412 to which the base of the “T” is fixed and connected.

Thus, the device may comprise at least two sensors 41 and 42 placed so as to carry out a measurement in at least two different places of the same contact zone ZP and thus enable a combination of the measurements LT1 and LT2 of these two sensors compensating for a variation in measurement linked to the angle of insertion A between the rollers.

Each of these two sensors is connected to the calculation means so as to measure on the one hand the length of resistive track short-circuited by the pressure in the nip zone ZT, and on the other hand the length L1 and L2 of the resistors R1 and R2 (cf. FIG. 4) situated on each side of this nip zone. If the measurement device is inserted with an angular displacement A relative to the normal NP to the axis of the nip zone ZP and the axes of the rollers, the calculation means use these lengths L1 and L2, obtained for each of the two sensors, to compensate short-circuited length value measured in the sensors, in order to obtain a value LT corresponding better to the width of the real width of the contact zone between the rollers.

Of course, the invention is not limited to the examples which have just been described and numerous adjustments may be made to these examples without exceeding the scope of the invention.

1. Device for measuring the width (LT) of a nip contact zone between two rollers (RA, RB), operating by insertion of at least one thin sensor between said rollers, this device comprising on the one hand a handling part (12) for introducing said sensor between the rollers to be tested and on other hand a measurement part comprising said sensor, the shape of this measurement part having a back tab (14) arranged such that, when the sensor is in the measurement position, the mechanical links (131) connecting the sensor to the handling part are situated in the nip zone or on the side opposite to the handling part relatively to said nip zone (ZP).

2. Device according to claim 1, characterized in that the measurement part comprises a tongue (13), one end of which forms a back tab (14) towards the handling part, this back tab carrying the sensor in a zone closer to the handling part than the part (131) of the tongue holding said back tab.

3. Device according to claim 2, characterized in that the sensor comprises a linear detection zone capable of carrying out a measurement at different insertion depths between the rollers, at least one of the ends of this detection zone having a region (25, 26) forming an end marker the detection features of which are chosen so as to deliver a measured value which is significantly different when the nip zone (ZP) to be measured meets said end point.

4. Device according to claim 1, characterized in that the sensor comprises a detection zone along a line having a symmetry around the axis of insertion of the tongue (13), this line being arranged such that the nip zone (ZP) crosses the detection zone in two separate portions of its line and the combined lengths (LT3, LT4) of which represent a value more or less independent of the angle of insertion (A) of said tongue.

5. Device according to claim 3, characterized in that the sensor has at least one linear detection zone comprising a resistive track (21) and a conductive track (22) arranged facing each other in what is called the active zone and that the compression places in contact with each other over the width (LT) of the contact zone (ZP), thus varying the ohmic resistance (R0) of an electric circuit comprising all or part of the resistive track (21) and through which an electric current passes, thus detecting this resistance or its variation.

6. Device according to claim 5, characterized in that the design of the resistive tracks (21) and conductive tracks (22) is arranged so as to short-circuit at least part of the resistance (R0) of the circuit when the contact zone meets at least one end of the linear detection zone, thus creating an end marker (25, 26).

7. Device according to claim 5, characterized in that the tongue (13) comprises at least two stacked films (31, 32) carrying the resistive track (21) and conductive track (22) on their facing sides, said tracks being formed by an ink having respectively resistive and conductive characteristics.

8. Device according to claim 5, characterized in that at least one linear detection zone contains at least one region bearing an insulation layer (341, 342) sufficiently thick that the tracks (21, 22) facing each other are not in contact unless they are subjected to compression by the rollers.

9. Device according to claim 8, characterized in that the facing tracks (21, 22) between them make an electric contact by means of at least one carbon-based substance, and are spaced apart by at least one layer of insulating varnish creating a calibrated space around at least one part of the active zone.

10. Device according to claim 7, characterized in that the space between the films (31, 32) is closed substantially tight around the active zone.

11. Device according to claim 10, characterized in that the part (14) of the tongue (13) forming the sensor is arranged such that the space between the films (31, 32) around the active zone communicates on either side of the nip zone.

12. Device according to claim 7, characterized in that the films (31, 32) of the tongue (13) comprise linking conductive tracks (23, 24, 221) drawn on the same face as the detection tracks (21, 22) and connecting said detection tracks with at least one electric measurement device (10), said tongue comprising at least one linking part in which at least one film carrying the tracks is cut out (310, 320) or folded such that its face carrying the lining track (220, 230, 240) appears on the external face of said tongue.

13. Device according to claim 2, characterized in that the tongue (13) comprises a part (132) which is more flexible than the remainder of said tongue and situated between the handling part (12) and the back tab (14) carrying the sensor, said flexible part (132) carrying out an articulation reducing the mechanical forces transmitted from said handling part.

14. Method for measuring the width (LT) of a nip contact zone between two rollers (RA, RB), by a device with an interchangeable sensor using measurement of the reduction, relative to a reference value, of the ohmic resistance of an electric circuit comprising a resistive track (21) short-circuited by contact with a conductive track (22) over a nip length, within a thin sensor inserted between said rollers, this method carrying out a session of several measurements with the same sensor, and comprising the following steps at the start of the session:
measurement of the ohmic resistance of the electric circuit under stand-by conditions and comparison of the value obtained, termed initial value, with a range of values termed wide range associated with said sensor;
if the initial value is within the wide range, storage of a range of values, termed narrow range, associated with said sensor and obtained from the initial value;
the method also comprising, during said session, an iteration of the following steps:
measurement of the ohmic resistance of the electric circuit, and comparison of the value obtained with the narrow range;
if the value obtained is within the narrow range, storage of a new narrow range, determined from the value obtained;
if the value obtained is outside the narrow range, calculation of a measured value, determined from the value obtained and a reference value dependent on the narrow range.

15. Method for measuring the width (LT) of a nip contact zone between two rollers (RA, RB), by a device with an interchangeable sensor using measurement of the reduction, relative to a reference value, of the ohmic resistance of an electric circuit comprising a resistive track (21) short-circuited by contact with a conductive track (22) over a nip length, within a thin sensor inserted between said rollers, this method comprising:
on the one hand, a calibration combined with a particular sensor and comprising the following steps:
insertion of the sensor between the rollers during a continuous rotation of said rollers at a constant speed or on a known travel;
during this insertion, automatic carrying out of a plurality of measurements at different insertion depths corresponding to different measurement positions on said sensor;
storage of a profile corresponding to said sensor and comprising said measurements, or their variations, each linked with their corresponding measurement position; and
on the other hand, using said sensor, at least one measurement of nip width (LT) comprising the following steps:
measurement of at least a resistance providing a measured value of nip width as well as a measurement position on the sensor for said measurement;
comparison of said measurement position with at least one datum from the profile corresponding to said sensor;
according to the results of this comparison, modification of the measured value to give a corrected value of the nip width (LT).

16. Device according to claim 1, characterized in that the sensor has at least one linear detection zone comprising a resistive track (21) and a conductive track (22) arranged facing each other in what is called the active zone and that the compression places in contact with each other over the width (LT) of the contact zone (ZP), thus varying the ohmic resistance (R0) of an electric circuit comprising all or part of the resistive track (21) and through which an electric current passes, thus detecting this resistance or its variation.

17. Device according to claim 6, characterized in that the tongue (13) comprises at least two stacked films (31, 32) carrying the resistive track (21) and conductive track (22) on their facing sides, said tracks being formed by an ink having respectively resistive and conductive characteristics.

18. Device according to claim 2, characterized in that the sensor comprises a detection zone along a line having a symmetry around the axis of insertion of the tongue (13), this line being arranged such that the nip zone (ZP) crosses the detection zone in two separate portions of its line and the combined lengths (LT3, LT4) of which represent a value more or less independent of the angle of insertion (A) of said tongue.

19. Device according to claim 3, characterized in that the sensor comprises a detection zone along a line having a symmetry around the axis of insertion of the tongue (13), this line being arranged such that the nip zone (ZP) crosses the detection zone in two separate portions of its line and the combined lengths (LT3, LT4) of which represent a value more or less independent of the angle of insertion (A) of said tongue.

20. Device according to claim 6, characterized in that at least one linear detection zone contains at least one region bearing an insulation layer (341, 342) sufficiently thick that the tracks (21, 22) facing each other are not in contact unless they are subjected to compression by the rollers.
